(19) United States
(12) Patent Application Publication
(10) Pub. No.: US 2019/0152267 A1
(43) Pub. Date: May 23, 2019

(54) PNEUMATIC TIRE

(71) Applicant: Toyo Tire & Rubber Co., Ltd., Itami-shi (JP)

(72) Inventor: Akinori Miyake, Itami-shi (JP)

(73) Assignee: Toyo Tire & Rubber Co., Ltd., Itami-shi (JP)

(21) Appl. No.: 16/180,422

(22) Filed: Nov. 5, 2018

(30) Foreign Application Priority Data
Nov. 20, 2017 (JP) 2017-223002

(51) Int. Cl. B60C 11/03

(52) U.S. Cl. CPC B60C 11/032

(57) ABSTRACT

In a pneumatic tire including plural small holes that are provided at spaced intervals along a tire circumferential direction on an inner side of a ground contact end of a tread in a tire width direction, each of the plural small holes is an elongated hole whose cross section is in an elongated circular shape, and is arranged such that a longitudinal direction thereof is tilted with respect to the tire width direction.

### BACKGROUND OF THE INVENTION

### 1. Field of the Invention

The present invention relates to a pneumatic tire.

### 2. Description of the Related Art

In general, a pneumatic tire tends to have a high ground contact pressure in a portion near a ground contact end of a tread during travel. Thus, the pneumatic tire has a problem of uneven wear that causes an amount of wear in the portion near the ground contact end of the tread to be larger than that of the rest of the portions. As disclosed in JP-A-5-294112 and JP-A-62-59107, as a method of suppressing such uneven wear, it has been known to provide plural small holes, each of which is opened to a tread surface, in the portion near the ground contact end of the tread, so as to lower rigidity of the portion near the ground contact end and uniformize the ground contact pressure.

In the cases where the plural small holes, each of which is opened to the tread surface, are provided as in JP-A-5-294112 and JP-A-62-59107 and where it is desired to acquire a high effect of lowering the ground contact pressure, it is required to increase a cross-sectional area of each of the small holes provided in the portion near the ground contact end. However, in the case where the cross-sectional area of each of the small holes is increased, an area of an opening that is formed in the tread surface is also increased. As a result, each of the small holes is more likely to bite a stone during the travel and thus is more likely to crack.

### SUMMARY OF THE INVENTION

In view of the above, the present invention has a purpose of providing a pneumatic tire that includes small holes in a tread, that can efficiently lower rigidity of a portion near a ground contact end of the tread, and that can suppress uneven wear while suppressing each of the small holes from biting a stone.

A pneumatic tire of the present invention is a pneumatic tire including plural small holes that are provided at spaced intervals along a tire circumferential direction on an inner side of a ground contact end of a tread in a tire width direction. In the pneumatic tire, each of the plural small holes is an elongated hole whose cross section is in an elongated circular shape, and is arranged such that a longitudinal direction thereof is tilted with respect to the tire width direction.

### BRIEF DESCRIPTION OF THE DRAWINGS

FIG. 1 is a perspective view of a half cross section of a pneumatic tire according to an embodiment of the present invention.

FIG. 2 is a plan view of small holes that are provided in a tread.

### DESCRIPTION OF THE PREFERRED EMBODIMENTS

A description will hereinafter be made on an embodiment of the present invention with reference to the drawings.

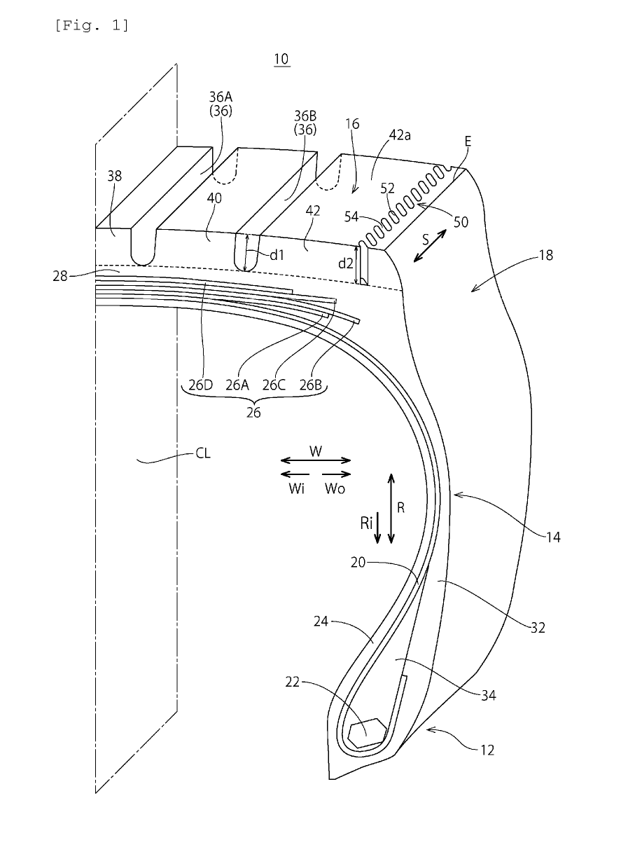

FIG. 1 is a perspective view of a right-half cross section of a pneumatic tire 10 according to the embodiment, and the right-half cross section is taken along a meridian cross section that includes a tire axis. Since the pneumatic tire 10 is a bilaterally symmetrical tire, a left-half portion thereof is not illustrated.

The pneumatic tire 10 in FIG. 1 includes: a right and left pair of beads 12; a right and left pair of sidewalls 14, each of which extends radially outward from the bead 12; a tread 16 that constitutes a tread surface; and a right and left pair of buttress portions 18, each of which is arranged on an inner side of the tread 16 in a tire radial direction. Here, each of the buttress portions 18 is a boundary region between the tread 16 and the sidewall 14 and is provided to connect the tread 16 and the sidewall 14.

The pneumatic tire 10 includes a carcass ply 20 that is stretched toroidally between the pair of the beads 12. A ring-shaped bead core 22 is embedded in each of the paired beads 12.

The carcass ply 20 is stretched from the tread 16 to the bead 12 through the buttress portion 18 and the sidewall 14, and is locked by the bead core 22 in the bead 12. In this way, the carcass ply 20 reinforces each of the above portions 12, 14, 16, 18. In this example, each end of the carcass ply 20 is folded around the bead core 22 from an inner side to an outer side thereof in a tire width direction, and is thereby locked. An inner liner 24 that keeps an air pressure is disposed on an inner side of the carcass ply 20.

The carcass ply 20 includes at least a single ply in which organic fiber cords or steel cords are arranged at a specified angle (for example, 70° to 90°) with respect to a tire circumferential direction S and are covered with topping rubber. In this example, the carcass ply 20 is configured to include the single ply. As the organic fiber cords that constitute the carcass ply 20, for example, polyester fiber cords, rayon fiber cords, aramid fiber cords, or nylon fiber cords are preferably used.

In each of the sidewalls 14, sidewall rubber 32 is provided on an outer side of the carcass ply 20 (that is, on a tire outer surface side). In addition, in each of the beads 12, a bead filler 34 is disposed on an outer circumferential side of the bead core 22. The bead filler 34 is made from a rubber material and extends outward in the tire radial direction so as to form a wedge.

In the tread 16, a belt 26 is disposed on an outer circumferential side of the carcass ply 20. That is, the belt 26 is provided between the carcass ply 20 and tread rubber 28 in the tread 16. The belt 26 includes plural crossed belt plies in which belt cords are arranged at a specified angle (for example, 10° to 65°) with respect to the tire circumferential direction S. As the belt cords, the steel cords or the organic fiber cords with a high tensile force are used.

In this example, the belt 26 has a four-layer structure that includes: a first belt 26A that is located on an innermost side Ri in the tire radial direction; and a second belt 26B, a third belt 26C, and a fourth belt 26D that are sequentially stacked on an outer circumferential side of the first belt 26A. Of the belts, the second belt 26B is a maximum width belt having the greatest width.

Plural main grooves 36, each of which extends along the tire circumferential direction S, are provided on a surface of the tread 16. More specifically, in the case where the four main grooves 36 are provided, the main grooves 36 are configured to include: a pair of main center grooves 36A disposed on both sides of a tire equatorial plane CL; and a pair of main shoulder grooves 36B provided on outer sides Wo of the paired main center grooves 36A in the tire width direction. The outer side Wo in the tire width direction is a side that is away from the tire equatorial plane CL in a tire width direction W.

In the tread 16, the above four main grooves 36 form a center land 38 between the two main center grooves 36A, an intermediate land 40 between each of the main center grooves 36A and each of the main shoulder grooves 36B, and a shoulder land 42 on the outer side Wo of each of the two main shoulder grooves 36B in the tire width direction.

In this example, each of the center land 38, the intermediate lands 40, and the shoulder lands 42 is a rib that continues in the tire circumferential direction S. Note that each of the center land 38, the intermediate lands 40, and the shoulder lands 42 may be a row of blocks that are divided in the tire circumferential direction S by lateral grooves.

In each of the shoulder lands 42, an outer end of a tread surface 42a in the tire width direction is a tread ground contact end E. The buttress portion 18, which extends inward Ri in the tire radial direction and constitutes an upper portion of a tire lateral surface, is connected to the tread ground contact end E.

Each of the shoulder lands 42 is provided with plural small holes 52, each of which is opened to the tread surface 42a, at spaced intervals along the tire circumferential direction S.

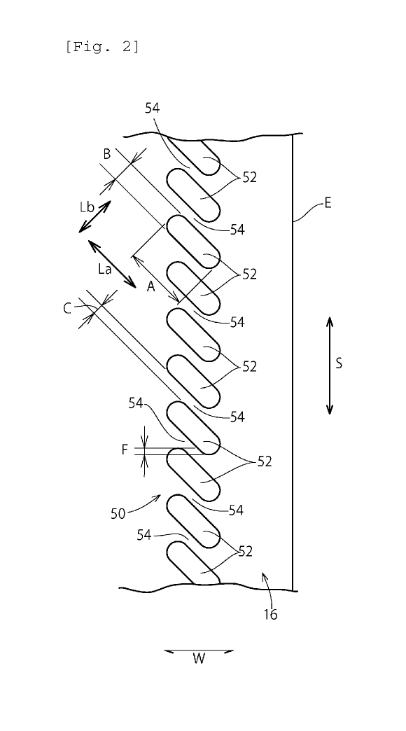

The plural small holes 52 have the same elongated hole shape. More specifically, each of the small holes 52 is a recess that is dented substantially inward Ri in the tire radial direction. As illustrated in FIG. 2, a cross-sectional shape of each of the small holes 52 (a shape of an opening end opened to the tread surface 42a) is the elongated hole shape in which short sides of a rectangle have semicircular shapes. Note that the short sides of each of the small holes 52 are not limited to have the semicircular shapes but may have arcuate shapes, each of which has a greater curvature radius than length B of each of the small holes 52 in a short direction Lb, for example.

The plural small holes 52 are arranged in parallel with each other such that a longitudinal direction La of each of the small holes 52 is tilted obliquely with respect to the tire width direction W. For example, a tilt angle of the longitudinal direction La of each of the small holes 52 with respect to the tire width direction W can be set to be equal to or larger than 25° and be equal to or smaller than 65°. In addition, the plural small holes 52 are arranged adjacently to each other such that each adjacent pair of the small holes 52 in the tire circumferential direction S overlaps in a portion F when the small holes 52 are projected in the tire width direction W.

A bridge portion 54 is formed between each of such plural small holes 52 and the adjacent small hole 52 thereof in the tire circumferential direction S. That is, a small hole row 50 is formed in a portion near the ground contact end E of each of the shoulder lands 42. In the small hole row 50, the small holes 52 and the bridge portions 54 are alternately arranged in the tire circumferential direction S. The bridge portions 54 couple the outer side Wo of the plural small holes 52 in the tire width direction and an inner side Wi thereof in the tire width direction.

Here, dimensions of the small hole row 50 will be exemplified with reference to FIG. 1 and FIG. 2. Length A of each of the small holes 52 in the longitudinal direction La can be set to 4 to 8 mm, the length B of each of the small holes 52 in the short direction Lb can be set to 1.5 to 3 mm, and width C of each of the bridge portions (an interval between each adjacent pair of the small holes 52) can be set to 1 to 2 mm. The width C of each of the bridge portions 54 is preferably less than the length B of each of the small holes 52 in the short direction Lb. In addition, depth d2 of each of the small holes 52 can be approximately equal to groove depth d1 of each of the main shoulder grooves 36B (for example, 90% to 110% of the groove depth d1) and can be set to 10 to 20 mm, for example.

Note that the above dimensions in the present specification are those in a legitimate unloaded state of the pneumatic tire that is attached to a legitimate rim and has a legitimate internal pressure unless otherwise noted. In addition, in the present specification, the ground contact end is an end of the tread surface, which contacts a road surface, in the tire width direction in a legitimate loaded state of the pneumatic tire that is assembled to the legitimate rim and has the legitimate internal pressure. In the legitimate loaded state, the pneumatic tire is placed perpendicularly on the flat road surface and is applied with a legitimate load.

In a system of standards including a standard with which the tire complies, the legitimate rim is a rim that is defined per tire in the standard. For example, the legitimate rim is specified as the “standard rim” in JATMA, the “Design Rim” in TRA, and the “Measuring Rim” in ETRTO. In the system of the standards including the standard with which the tire complies, the legitimate internal pressure is the air pressure that is defined per tire in the standard, and is specified as the “maximum inflation pressure” in JATMA, a maximum value set in the table “TIRE LOAD LIMITS AT VARIOUS COLD INFLATION PRESSURES” in TRA, and the “INFLATION PRESSURE” in ETRTO. In the system of the standards including the standard with which the tire complies, the legitimate load is a load that is defined per tire in the standard, and is specified as the “maximum load capacity” in JATMA, the maximum value set in the above table in TRA, and the “LOAD CAPACITY” in ETRTO.

In the pneumatic tire 10 of this embodiment as described so far, each of the plural small holes 52 is an elongated hole whose cross section is in the elongated circular shape, and is arranged such that the longitudinal direction La thereof is tilted with respect to the tire width direction W. Thus, the bridge portion 54, which is tilted with respect to the tire width direction W, is formed between each adjacent pair of the plural small holes 52. Each of such bridge portions 54 collapses and is deformed when receiving a load in the tire width direction W. Therefore, even when cross-sectional areas of the small holes 52 are small, rigidity of the portion near the ground contact end E can efficiently be lowered, and uneven wear of the pneumatic tire 10 can be suppressed while each of the small holes 52 is suppressed from biting a stone.

In this embodiment, the plural small holes 52 are arranged such that each of the small holes 52 overlaps the portion F of the adjacent small hole 52 in tire circumferential direction S when being projected in the tire width direction W. Thus, each of the bridge portions 54 is further likely to be bent when receiving the load in the tire width direction W. Therefore, in the portion near the ground contact end E, the rigidity of each of the shoulder lands 42 can further efficiently be lowered.

In this embodiment, the length B of each of the plural small holes 52 in the short direction Lb is set to be equal to or longer than the interval C between each adjacent pair of the small holes 52, and the bridge portions 54, each of which has the relatively narrow width, are thereby formed. Thus, each of the bridge portions 54 is further likely to be bent when receiving the load in the tire width direction W. Therefore, in the portion near the ground contact end E, the rigidity of each of the shoulder lands 42 can further efficiently be lowered.

In the pneumatic tire 10 of this embodiment, the depth d2 of each of the small holes 52 is set to be approximately equal to the groove depth d1 of each of the main shoulder grooves 36B. Therefore, an uneven wear suppression effect can be exerted by the small holes 52 until the last stage of the tire wear.

The above embodiment is merely provided as an example and thus has no intention of limiting the scope of the invention. This novel embodiment can be implemented in any of various other modes, and various types of elimination, replacement, and changes can be made thereto within the scope that does not depart from the gist of the invention.

What is claimed is:

1. A pneumatic tire comprising:
plural small holes that are provided at spaced intervals along a tire circumferential direction on an inner side of a ground contact end of a tread in a tire width direction, wherein
each of the plural small holes is an elongated hole whose cross section is in an elongated circular shape, and is arranged such that a longitudinal direction thereof is tilted with respect to the tire width direction.

2. The pneumatic tire according to claim 1, wherein
each of the plural small holes is arranged in a manner to partially overlap the adjacent small hole in tire circumferential direction when being projected to the tire width direction.

3. The pneumatic tire according to claim 1, wherein
length of each of the small holes in a short direction is equal to or longer than an interval between each adjacent pair of the small holes.

4. The pneumatic tire according to claim 1, wherein
the plural small holes have the same shape.

5. The pneumatic tire according to claim 1, wherein
a side of each of the small holes in a short direction has a semicircular shape.

6. The pneumatic tire according to claim 1, wherein
a tilt angle of the longitudinal direction of each of the small holes with respect to the tire width direction is equal to or larger than 25° and is equal to or smaller than 65°.

7. The pneumatic tire according to claim 1, wherein
length of each of the small holes in the longitudinal direction is 4 to 8 mm.

8. The pneumatic tire according to claim 1, wherein
length of each of the small holes in a short direction is 1.5 to 3 mm.

9. The pneumatic tire according to claim 1 further comprising:
a main shoulder groove that extends along the tire circumferential direction, wherein
depth of each of the small holes is 90 to 110% of groove depth of the main shoulder groove.
